(19) United States
(12) Patent Application Publication
(10) Pub. No.: US 2025/0322265 A1
(43) Pub. Date: Oct. 16, 2025

(54) Industrial Data Processing Method and Apparatus for Edge Device

(71) Applicant: Siemens Aktiengesellschaft, München (DE)

(72) Inventors: Lu Wang, Qingdao (CN); Zhi Qiang Yu, Qingdao (CN); Qi Yu, Nanjing (CN)

(73) Assignee: Siemens Aktiengesellschaft, München (DE)

(21) Appl. No.: 18/868,911

(22) PCT Filed: May 26, 2022
(86) PCT No.: PCT/CN2022/095352

§ 371 Date: Nov. 25, 2024

(51) Int. Cl. G06N 5/022; G06F 18/25

(52) U.S. Cl. CPC G06N 5/022; G06F 18/25

(57) ABSTRACT

Various embodiments of the teachings herein include an industrial data processing method for an edge device. An example includes: collecting real-time data from a field device; constructing a first knowledge graph stored in the edge device, wherein the first knowledge graph comprises first ontology; and creating an instance by using the first ontology of the first knowledge graph and according to the real-time data, to fuse the real-time data with the first knowledge graph.

### CROSS-REFERENCE TO RELATED APPLICATIONS

This application is a U.S. National Stage Application of International Application No. PCT/CN2022/095352 filed May 26, 2022, which designates the United States of America, the contents of which are hereby incorporated by reference in their entirety.

### TECHNICAL FIELD

The present disclosure relates to industrial digitization. Various embodiments of the teachings herein include an industrial data processing method and apparatus for an edge device.

### BACKGROUND

Currently, the amount of industrial data is huge, data sources from field devices have different protocols, and a plurality of third-party commercial software (for example, enterprise resource planning (ERP) and a manufacturing execution system (MES)) has own historian. The data sources or the historian construct free databases by using different data models, which makes it very difficult to fuse data from the field devices and the third-party commercial software.

In the related art, some manufactures perform data fusion by using a predefined policy. The method is mainly applicable to a relational database. However, the data of the industrial field devices and the historian of the third-party commercial software construct the free databases by using different data models. As a result, the predefined policy cannot be applied to fusion of the data of the industrial field devices or the third-party commercial software.

### SUMMARY

In order to resolve the foregoing technical problems, the present disclosure describes industrial data processing methods and apparatus for an edge device to fuse data from industrial field devices. For example, some embodiments of the teachings herein include an industrial data processing method for an edge device. An example industrial data processing method includes: collecting real-time data from a field device; constructing a first knowledge graph stored in the edge device, where the first knowledge graph includes first ontology; and creating an instance by using the first ontology of the first knowledge graph and according to the real-time data, to fuse the real-time data with the first knowledge graph. Therefore, an instance is created by using ontology of a knowledge graph and according to real-time data, and the real-time data is fused with the knowledge graph, so that a data structure of industrial data may be unified, to avoid complex conversion between different data structures, thereby fusing the industrial data.

In some embodiments, after the fusing the real-time data with the first knowledge graph, the method further includes: performing data reasoning on the fused data, to obtain first reasoned data, and updating the first ontology according to the first reasoned data. Therefore, reasoning is performed on the fused data, to expand a data type of the ontology and enrich information about the ontology, thereby improving a capacity of a knowledge graph on an edge side.

In some embodiments, the method further includes: matching the first ontology with second ontology of a second knowledge graph of a server, and fusing the first ontology with the second ontology. Therefore, the first ontology is fused with second ontology, to improve a capacity of a knowledge graph on a server side.

In some embodiments, the method further includes: collecting external data from third-party software, and creating an instance by using the second ontology of the second knowledge graph and according to the external data, to fuse the external data with the second knowledge graph. Therefore, an instance is created by using ontology of a knowledge graph and according to external data, and the external data is fused with the knowledge graph, so that a data structure of the external data may be unified, to avoid complex conversion between different data structures, thereby fusing the external data.

In some embodiments, the constructing a first knowledge graph stored in the edge device includes: receiving domain knowledge inputted by a user and creating the first knowledge graph according to the domain knowledge. Therefore, the knowledge graph is constructed by using domain knowledge inputted by a user, to achieve flexibility of construction of the knowledge graph.

As another example, some embodiments include an industrial data processing apparatus for an edge device. An example industrial data processing apparatus includes: a collection module, configured to collect real-time data from a field device; a construction module, configured to construct a first knowledge graph stored in the edge device, where the first knowledge graph includes first ontology; and a fusion module, configured to create an instance by using the first ontology of the first knowledge graph and according to the real-time data, to fuse the real-time data with the first knowledge graph.

In some embodiments, after fusing the real-time data with the first knowledge graph, the fusion module is further configured to perform data reasoning on the fused data, to obtain first reasoned data, and update the first ontology according to the first reasoned data.

In some embodiments, the apparatus further includes matching the first ontology with second ontology of a second knowledge graph of a server and fusing the first ontology with the second ontology.

In some embodiments, the apparatus further includes collecting external data from third-party software and creating an instance by using the second ontology of the second knowledge graph and according to the external data, to fuse the external data with the second knowledge graph.

In some embodiments, the construction of the first knowledge graph stored in the edge device by the construction module includes receiving domain knowledge inputted by a user and constructing the first knowledge graph according to the domain knowledge.

As another example, some embodiments include an electronic device including a processor, a memory, and instructions stored in the memory, where the instructions, when being executed by the processor, implement one or more of the foregoing methods.

As another example, some embodiments include a computer-readable storage medium, storing computer instructions, where the computer instructions, when run, perform one or more of the foregoing methods.

### BRIEF DESCRIPTION OF THE DRAWINGS

The following figures are only intended to give schematic illustrations and explanations of the teachings of the present disclosure but are not intended to limit the scope thereof. In the figures:

FIG. 1 is a flowchart of an example industrial data processing method incorporating teachings of the present disclosure;

FIG. 2 is a schematic diagram of an example of an implementation environment of an industrial data processing method incorporating teachings of the present disclosure;

FIG. 3 is a schematic diagram of an industrial data processing apparatus incorporating teachings of the present disclosure; and

FIG. 4 is a schematic diagram of an electronic device incorporating teachings of the present disclosure.

### DESCRIPTIONS OF REFERENCE NUMERALS

100. Industrial data processing method
110-130. Steps
21. Industrial field device
22. Edge device
221. First data obtaining unit
222. First knowledge graph
222a. First fusion unit
222b. First reasoning unit
222c. First ontology library
222d. First ontology access unit
223. Real-time cache
224. Storage scheduler
225. Storage forwarder
226. First historian
227. First historian interface
23. Server
231. Second data obtaining unit
232. Second knowledge graph
232a. Second fusion unit
232b. Second reasoning unit
232c. Second ontology library
232d. Ontology matching unit
233. Second historian
234. Second historian interface
24. Third-party software
25. Data access interface
300. Industrial data processing apparatus
310. Collection module
320. Construction module
330. Fusion module
400. Electronic device
410. Processor
420. Memory

### DETAILED DESCRIPTION

In order to have a clearer understanding of the technical features, the objectives, and the effects of teachings of the present disclosure, specific implementations are now illustrated with reference to the accompanying drawings. Many specific details are set forth in the following description to facilitate a full understanding, but the teachings may alternatively be implemented in other manners different from those described herein and is therefore not limited by specific embodiments disclosed below.

As shown in the present application and the claims, words such as “a/an,” “one,” “one kind,” and/or “the” do not refer specifically to singular forms and may also include plural forms, unless the context expressly indicates an exception. In general, terms “comprise” and “include” merely indicate including clearly identified steps and elements. The steps and elements do not constitute an exclusive list. A method or a device may also include other steps or elements.

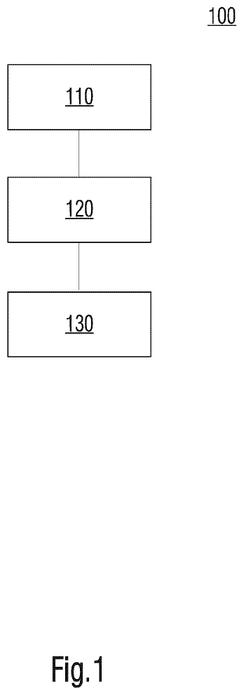

Some examples include an industrial data processing method for an edge device. FIG. 1 is a flowchart of an industrial data processing method 100 incorporating teachings of the present disclosure. As shown in FIG. 1, the industrial data processing method 100 includes the following:

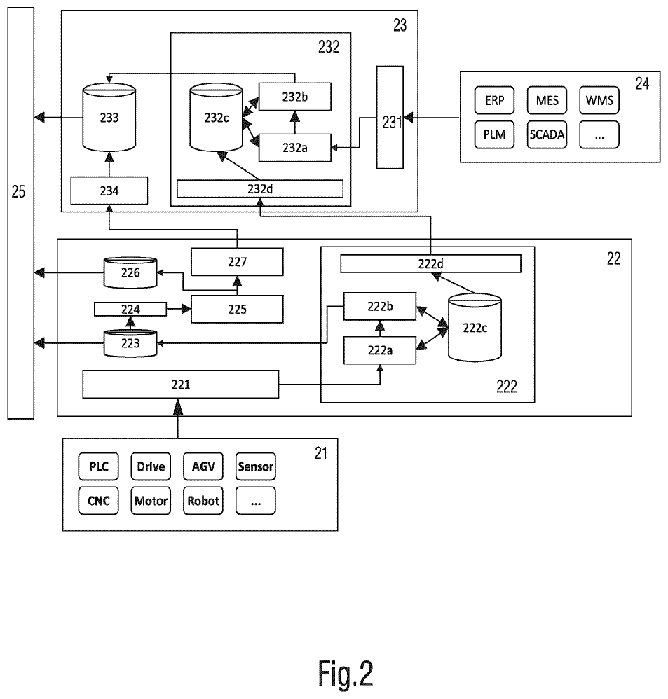

Step 110. Collect real-time data from a field device. The field device is a device located in an industrial field for controlling, execution, and supervision. Such field devices form a complete workflow. During running, the field device generates real-time data. Different data models are adopted for real-time data generated by different field devices. In the step, the real-time data generated by the field device is collected. FIG. 2 is a schematic diagram of an example of an implementation environment of an industrial data processing method incorporating teachings of the present disclosure. As shown in FIG. 2, field device 21 may include a programmable logic controller (PLC), a drive, an automated guided vehicle (AGV), a sensor, a computer numerical control (CNC) machine tool, a motor, a robot, and the like. The field device sends, by using a communication protocol, real-time data generated during running to a first data obtaining unit 221 in an edge device 22

Step 120. Construct a first knowledge graph stored in an edge device, where the first knowledge graph includes first ontology. A knowledge graph is used for describing an objective relationship among an entity, a concept, and an event in the real world, and the knowledge graph is formed by ontology and data. The ontology is a semantic data model. In some embodiments, constructing a first knowledge graph stored in an edge device includes: receiving domain knowledge inputted by a user and creating the first knowledge graph according to the domain knowledge.

Specifically, a user may input domain knowledge such as a current, a voltage, a pose, a moment, and a driving force through a human machine interface (HMI), to define ontology, and then construct a first knowledge graph according to the defined ontology. As shown in FIG. 2, the edge device 22 includes a first knowledge graph 222. The first knowledge graph 222 includes a first ontology library 222c, and the first ontology library 222c stores first ontology. In some embodiments, the first knowledge graph is a knowledge graph stored in an edge device. The second knowledge graph is a knowledge graph stored in a server. Correspondingly, the first ontology is ontology stored in the knowledge graph in the edge device, and the second ontology is ontology stored in the knowledge graph in the server.

Step 130. Create an instance by using the first ontology of the first knowledge graph and according to the real-time data, to fuse the real-time data with the first knowledge graph. The first ontology of the first knowledge graph is a semantic data model and is configured to define a relationship between data types. After the real-time data is obtained, the first ontology creates an instance according to the real-time data, to fuse the real-time data with the first knowledge graph. The creating, by the first ontology, an instance according to the real-time data may include: matching the real-time data with a data type of the first ontology and fusing the real-time data with the matched data type.

For example, the real-time data is a driving current value of 10 A and a driving voltage value of 100V of a motor at a moment, and the first ontology includes two data types of the driving current value and the driving voltage value, so that the driving current value of 10 A and the driving voltage value of 100V of the motor at the moment may be fused with the first knowledge graph. In another example, the real-time data is a pose of a mechanical arm of a robot at a moment, and the first ontology includes two data types of a position and a posture, so that the pose of the mechanical arm of the robot at the moment may be split into the position and the posture and then fused with the first knowledge graph. In still another example, the real-time data includes a name of a field device, and the first ontology includes a data type of a device type, so that the name of the field device may also be fused with the device type of the first ontology. An instance is created by using ontology of a knowledge graph and according to real-time data, and the real-time data is fused with the knowledge graph, so that a data structure of industrial data may be unified, to avoid complex conversion between different data structures, thereby fusing the industrial data.

As shown in FIG. 2, a first fusion unit 222a receives industrial data sent by the first data obtaining unit 221 and fuses the industrial data. The fused data is stored in the first ontology library 222c.

In some embodiments, after the fusing the real-time data with the first knowledge graph, the method further includes: performing data reasoning on the fused data, to obtain first reasoned data, and updating the first ontology according to the first reasoned data. For example, the first ontology includes the two data types of the driving voltage value and the driving current value, a new data type of a driving power may be obtained through reasoning, and the new data type is added to the first ontology. Therefore, reasoning is performed on the fused data, to expand a data type of the ontology and enrich information about the ontology, thereby improving a capacity of a knowledge graph on an edge side. As shown in FIG. 2, the first fusion unit 222a sends the fused data to a first reasoning unit 222b, and the first reasoning unit 222b performs data reasoning on the fused data, to obtain first reasoned data, and updates the first ontology according e first reasoned data. Subsequently, the first reasoning unit 222b sends the data to a real-time cache 223. The real-time cache 223 sends the cached data to a storage scheduler 224. The storage scheduler 224 sends the data to the storage forwarder 225. The storage forwarder 225 sends the data to a first historian 226, to store the data on an edge side, and also sends the data to a first historian interface, to upload the data.

In some embodiments, the method 100 further includes: matching the first ontology with second ontology of a second knowledge graph of a server and fusing the first ontology with the second ontology. Therefore, the first ontology is fused with second ontology, to improve the capacity of a knowledge graph on a server side. As shown in FIG. 2, a first ontology access unit 222d sends the first ontology in the first ontology library 222c to an ontology matching unit 232d in a second knowledge graph 232 in a server 23. The ontology matching unit 232d matches the first ontology and then fuses the first ontology with a second ontology library 232c.

In some embodiments, the method 100 further includes: collecting external data from third-party software and creating an instance by using the second ontology of the second knowledge graph and according to the external data, to fuse the external data with the second knowledge graph. An instance is created by using ontology of a knowledge graph and according to external data, and the external data is fused with the knowledge graph, so that a data structure of the external data may be unified, to avoid complex conversion between different data structures, thereby fusing the external data. As shown in FIG. 2, third-party software 24 may be enterprise resource planning (ERP), a manufacturing execution system (MES), a warehouse management system (WMS), a supervisory control and data acquisition (SCADA) system, or the like. The server 23 obtains external data from the third-party software 24 by using a second data obtaining unit 231. A second fusion unit 232a fuses the external data. A second reasoning unit 232b performs reasoning on the fused data. The fused and reasoned data is stored in the second ontology library 232c. In addition, the fused data is further sent to a second historian 233, to store the data in the server. The second historian 233 further receives historical data on the edge side through a second historian interface 234.

In addition, a data access interface 25 is connected to the real-time cache 223, the first historian 226, and the second historian 233, to read the data in the real-time cache, the first historian and the second historian, so as to read the historical data and the real-time data on the edge side and the server side, thereby implementing multi-layer data access on the edge side and the server side.

In some embodiments, an instance is created by using ontology of a knowledge graph and according to real-time data, and the real-time data is fused with the knowledge graph, so that a data structure of industrial data may be unified, to avoid complex conversion between different data structures, thereby fusing the industrial data.

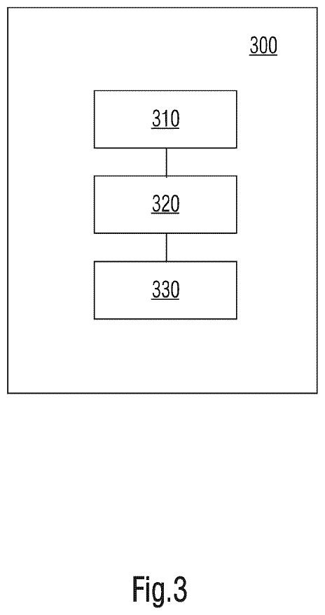

Some embodiments include an industrial data processing apparatus for an edge device. FIG. 3 is a schematic diagram of an industrial data processing apparatus 300 incorporating teachings of the present disclosure. As shown in FIG. 3, the industrial data processing apparatus 300 includes: a collection module 310, configured to collect real-time data from a field device; a construction module 320, configured to construct a first knowledge graph stored in an edge device, where the first knowledge graph includes first ontology; and a fusion module 330, configured to create an instance by using the first ontology of the first knowledge graph and according to the real-time data, to fuse the real-time data with the first knowledge graph.

In some embodiments, after fusing the real-time data with the first knowledge graph, the fusion module 330 is further configured to perform data reasoning on the fused data, to obtain first reasoned data and update the first ontology according to the first reasoned data.

In some embodiments, the apparatus 300 further includes matching the first ontology with second ontology of a second knowledge graph of a server and fusing the first ontology with the second ontology.

In some embodiments, the apparatus 300 further includes collecting external data from third-party software and creating an instance by using the second ontology of the second knowledge graph and according to the external data, to fuse the external data with the second knowledge graph.

In some embodiments, the construction of the first knowledge graph stored in the edge device by the construction module 330 includes receiving domain knowledge inputted by a user and constructing the first knowledge graph according to the domain knowledge.

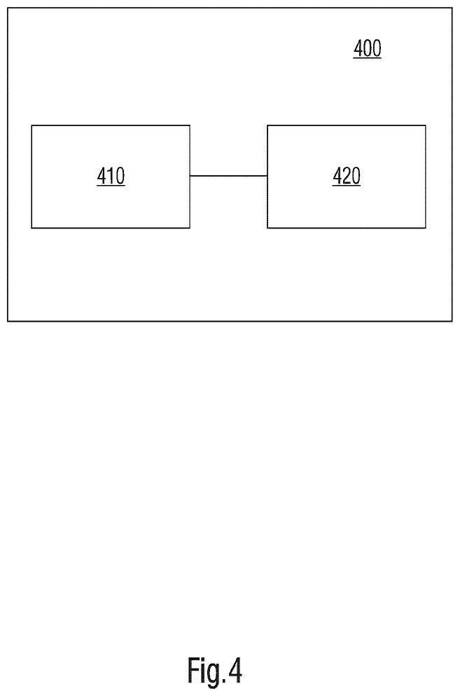

Some examples include an electronic device 400. FIG. 4 is a schematic diagram of an electronic device 400 incorporating teachings of the present disclosure. As shown in FIG. 4, the electronic device 400 includes a processor 410 and a memory 420. The memory 420 stores an instruction, and the instruction is executed by the processor 410 to implement one or more of the methods described herein.

Some embodiments include a computer-readable storage medium, storing computer instructions, where the computer instructions, when run, perform one or more of the foregoing methods.

Correspondingly, some aspects of the method or the apparatus may be entirely executed by hardware, may be entirely executed by software (including firmware, resident software, microcode, and the like), or may be executed by a combination of hardware and software. The hardware or software may be referred to as a “data block”, a “module”, an “engine”, a “unit”, a “component”, or a “system”. The processor may be one or more application specific integrated circuits (ASICs), a digital signal processor (DSP), a digital signal processing device (DSPD), a programmable logic device (PLC), a field programmable gate array (FPGA), a processor, a controller, a microcontroller, a microprocessor, a or combination thereof. In addition, the computer readable medium may include, but is not limited to, a magnetic storage device (for example, a hard disk, a floppy disk, or a magnetic tape), an optical disk (for example, a compact disc (CD) or a digital versatile disk (DVD), a smart card, and a flash memory (for example, a card, a stick, or a key drive).

Flowcharts are used herein for illustrating operations of the methods incorporating teachings of this disclosure. It should be understood that the foregoing operations are not necessarily strictly performed according to an order. On the contrary, the steps may be performed in a reverse order or simultaneously. Meanwhile, other operations may be added to the processes. Alternatively, one or more operations may be deleted from the processes.

Although this specification describes example embodiments, each embodiment may not include only one independent technical solution. The description manner of this specification is merely for clarity. This specification should be considered as a whole by a person skilled in the art, and the technical solution in each embodiment may also be properly combined, to form other implementations that can be understood by the person skilled in the art.

The foregoing are merely specific schematic implementations of the teachings of the present disclosure and are not intended to limit the scope thereof. Any equivalent change, modification, and combination made by the person skilled in the art without departing from the conception and principles of the present disclosure should all fall within the protection scope thereof.

What is claimed is:

1. An industrial data processing method for an edge device, the method comprising:
collecting real-time data from a field device;
constructing a first knowledge graph stored in the edge device, wherein the first knowledge graph comprises first ontology; and
creating an instance by using the first ontology of the first knowledge graph and according to the real-time data, to fuse the real-time data with the first knowledge graph.

2. The industrial data processing method according to claim 1, further comprising:
performing data reasoning on the fused data, to obtain first reasoned data after the fusing the real-time data with the first knowledge graph; and
updating the first ontology according to the first reasoned data.

3. The industrial data processing method according to claim 1, further comprising:
matching the first ontology with second ontology of a second knowledge graph of a server; and
fusing the first ontology with the second ontology.

4. The industrial data processing method according to claim 3, further comprising:
collecting external data from third-party software; and
creating an instance by using the second ontology of the second knowledge graph and according to the external data to fuse the external data with the second knowledge graph.

5. The industrial data processing method according to claim 1, wherein constructing a first knowledge graph stored in the edge device comprises:
receiving domain knowledge inputted by a user; and
creating the first knowledge graph according to the domain knowledge.

6. An industrial data processing apparatus for an edge device, the apparatus comprising:
a collection module to collect real-time data from a field device;
a construction module to construct a first knowledge graph stored in the edge device, wherein the first knowledge graph comprises first ontology; and
a fusion module to create an instance by using the first ontology of the first knowledge graph and according to the real-time data, to fuse the real-time data with the first knowledge graph.

7. The industrial data processing apparatus according to claim 6, wherein after fusing the real-time data with the first knowledge graph, the fusion module performs data reasoning on fused data, to obtain first reasoned data, and update the first ontology according to the first reasoned data.

8. The industrial data processing apparatus according to claim 6, wherein the fusion module matches the first ontology with second ontology of a second knowledge graph of a server and fuses the first ontology with the second ontology.

9. The industrial data processing apparatus according to claim 7, wherein the fusion module collects external data from third-party software and creates an instance by using the second ontology of the second knowledge graph and according to the external data, to fuse the external data with the second knowledge graph.

10. The industrial data processing apparatus according to claim 6, wherein construction of the first knowledge graph stored in the edge device by the construction module comprises:
receiving domain knowledge inputted by a user; and
constructing the first knowledge graph according to the domain knowledge.

11-12. (canceled)
